(19) United States
(12) Patent Application Publication
(10) Pub. No.: US 2025/0256732 A1
(43) Pub. Date: Aug. 14, 2025

(54) INTELLIGENT COCKPIT INTERACTION METHOD, DEVICE AND SYSTEM

(71) Applicant: XG TECH PTE. LTD., Singapore (SG)

(72) Inventor: Ziyu WANG, Singapore (SG)

(73) Assignee: XG TECH PTE. LTD., Singapore (SG)

(21) Appl. No.: 19/194,464

(22) Filed: Apr. 30, 2025

(30) Foreign Application Priority Data
Aug. 29, 2024 (CN) 202411206213.X

(51) Int. Cl. B60W 50/10; G10L 15/26; G10L 15/30

(52) U.S. Cl. CPC B60W 50/10; G10L 15/26; G10L 15/30

(57) ABSTRACT

Embodiments of the present disclosure provide an intelligent cockpit interaction method, means, and system, the intelligent cockpit including a first agent and at least one second agent, the method including: after acquiring a first interaction request, the first agent determining at least one target agent for processing the first interaction request, and the at least one second agent including the target agent; the first agent sending a first request information corresponding to the first interaction request to the target agent; and the target agent performing an operation corresponding to the first request information. The scheme provided by the embodiments of the present disclosure enables the interaction of intelligent cockpits, and the interaction process does not need to utilize semantic templates for semantic understanding, and thus does not need to develop corresponding semantic templates for various voice requests, thus enabling cost reduction.

### CROSS-REFERENCE TO RELATED APPLICATION

The present disclosure claims priority to Chinese Patent Application No. 202411206213.X, filed on Aug. 29, 2024, which is incorporated herein by reference in its entirety.

### FIELD OF THE PRESENT DISCLOSURE

The present disclosure relates to the technical field of artificial intelligence and, more particularly, to an intelligent cockpit interaction method, device and system.

### BACKGROUND OF THE PRESENT DISCLOSURE

Cockpit, also referred to as driving cabin or passenger compartment, generally refers to the space within a vehicle where users (e.g. drivers and passengers) are located. With the development of science and technology, a cockpit integrating various intelligent technologies (i.e. an intelligent cockpit) emerges, which can realize the interaction with the users in the vehicle.

When interacting with a user in a vehicle, the intelligent cockpit firstly performs voice recognition on the voice emitted by the user, and then performs semantic understanding on the recognition result via the developed semantic template so as to parse the recognition result into structured semantic information, and then calls a control interface corresponding to the semantic information to realize an operation indicated by the semantic information. Therefore, how to realize the cockpit interaction at low cost has become an urgent problem.

### SUMMARY OF THE PRESENT DISCLOSURE

In order to solve the above-mentioned technical problem, the present disclosure provides an intelligent cockpit interaction method (hereafter also referred to an intelligent cockpit interaction method) that implements the cockpit interaction at low cost.

In a first aspect of the present disclosure, there is provided an intelligent cockpit interaction method, the intelligent cockpit including a first agent and at least one second agent, the method including:
determining, at the first agent, at least one target agent for processing a first interaction request from among the at least one second agent after the first interaction request is acquired;
sending, at the first agent, a first request information corresponding to the first interaction request to the at least one target agent; and
performing, at the target agent, an operation corresponding to the first request information.

In a second aspect of the present disclosure, there is provided an intelligent cockpit interaction device, including:
a first agent, configured for determining at least one target agent for processing a first interaction request from among the at least one second agent after the first interaction request is acquired, and for sending a first request information corresponding to the first interaction request to the at least one target agent; and
the at least one target agent, configured for performing an operation corresponding to the first request information after receiving the first request information sent by the first agent.

In a third aspect of the present disclosure, there is provided a computer-readable storage medium storing a computer program thereon which, when executed by a processor, cause the processor to perform the method for intelligent cockpit interaction according to the above first aspect.

In a fourth aspect of the present disclosure, there is provided an electronic apparatus including:
a processor;
a memory for storing processor-executable instructions;
wherein the processor is used for reading the executable instructions from the memory and performing the instructions to implement the method for intelligent cockpit interaction according to the first aspect described above.

According to the scheme provided by the embodiments of the present disclosure, the first agent can distribute the first request information corresponding to the first interaction request to the target agent among the second agents, and then the target agent performs an operation corresponding to the first request information to achieve the interaction. Moreover, the interaction process does not need to utilize semantic templates for semantic understanding, and thus does not need to develop the corresponding semantic templates for various voice requests, which reduces the cost.

Further, in the schemes provided by embodiments of the present disclosure, the second agents may include one or more, and each of the second agents may perform a corresponding function. If the interaction demand increases, it is sufficient to reconfigure the corresponding second agent for the intelligent cockpit. Therefore, the scheme provided by the embodiments of the present disclosure has a better scalability, can be applied to a variety of interaction scenarios, and meets the diversified demand of users.

In addition, in current schemes, the intelligent cockpit is typically only able to interact based on voice requests. However, in the embodiments of the present disclosure, the first interaction request may include a voice request and/or a request triggered by a target event of the intelligent cockpit. If the first interaction request includes a voice request and a request triggered by the target event of the intelligent cockpit, the intelligent cockpit can perform the interaction both when the voice request is received and when the request is triggered by the target event. Thus, the embodiments of the present disclosure provide for a broader range of applications.

### BRIEF DESCRIPTION OF THE DRAWINGS

FIG. 1 is a schematic diagram of the architecture of an intelligent cockpit provided by an exemplary embodiment of the present disclosure.

FIG. 2 is a flow schematic diagram of an intelligent cockpit interaction method provided by an exemplary embodiment of the present disclosure.

FIG. 3 is a flow schematic diagram of an intelligent cockpit interaction method provided by another exemplary embodiment of the present disclosure.

FIG. 4 is an interaction schematic diagram of an intelligent cockpit interaction method provided by an exemplary embodiment of the present disclosure.

FIG. 5 is a flow schematic diagram of an intelligent cockpit interaction method provided by another exemplary embodiment of the present disclosure.

FIG. 6 is an interaction schematic diagram of an intelligent cockpit interaction method provided by another exemplary embodiment of the present disclosure.

FIG. 7 is a flow schematic diagram of an intelligent cockpit interaction method provided by another exemplary embodiment of the present disclosure.

FIG. 8 is a flow schematic diagram of an intelligent cockpit interaction method provided by another exemplary embodiment of the present disclosure.

FIG. 9 is a schematic diagram of the architecture of an intelligent cockpit provided by another exemplary embodiment of the present disclosure.

FIG. 10 is a hardware architecture diagram of an intelligent cockpit of a vehicle provided by another exemplary embodiment of the present disclosure.

FIG. 11 is a structure diagram of an electronic apparatus provided by an exemplary embodiment of the present disclosure.

### DESCRIPTION OF THE EMBODIMENTS

In order to explain the present disclosure, exemplary embodiments of the present disclosure will be described in detail below with reference to the accompanying drawings, it is apparent that the described embodiments are only a part of the embodiments of the present disclosure, not all of them, and it is to be understood that the present disclosure is not limited to the exemplary embodiments.

It should be noted that the relative arrangement, numerical expressions, and values of the components and steps described in these embodiments do not limit the scope of the present disclosure unless specified otherwise.

### Overview of Application

An intelligent cockpit is a cockpit that integrates a variety of intelligent technologies used to enable interaction with a user in a vehicle. For example, if the user wishes the vehicle to open the window, a “opening the window” voice may be emitted, and after the voice emitted by the user is collected by the intelligent cockpit, a corresponding operation may be performed, i.e. opening the window, so that interaction between the intelligent cockpit and the user is achieved.

When interacting with a user, an intelligent cockpit usually firstly performs voice recognition on a voice request emitted by the user, and then performs semantic understanding on the recognition result via the developed semantic template so as to parse the recognition result into structured semantic information, and then calls a control interface corresponding to the semantic information to realize an operation indicated by the semantic information.

For example, if a user emits a voice request of “opening the window”, after receiving the voice request, the intelligent cockpit firstly parses the voice request of “opening the window” into corresponding text information through voice recognition, wherein the text information is a recognition result; then, the intelligent cockpit parses the text information into structured semantic information through the developed semantic template, for example, in the example, the structured semantic information may be “{“domain”: “vechile”. “intent”: “open”, “slots”:{“object”: “window”}}”; then, the intelligent cockpit parses the structured semantic information and calls the window control interface to open the window, so as to realize the interaction between the intelligent cockpit and users.

However, this method requires developers to pre-configure multiple semantic templates, and the configuration of each semantic template requires manual effort of developers, which results in a large amount of manual effort and high cost for developers.

In particular, with the increasing popularity of intelligent cockpit applications in various vehicles and apparatus, users' expectations for intelligent cockpit are higher and higher, and the corresponding expectations for intelligent cockpit to be able to achieve more and more functions and more and more interaction demands. As a result, voice requests emitted by users for interaction are increasingly diverse, resulting in an increasing number of semantic templates that need to be developed by developers. For example, when the user only wishes to adjust the window, the voice request emitted may include a variety of “opening the window”, “closing the window”, “setting the window amplitude to xx”, etc. and accordingly, the semantic template to be developed also includes a variety of semantic templates. Accordingly, the costs associated with interacting in the manner described above are also increasing.

Therefore, how to realize the cockpit interaction at low cost has become an urgent problem.

To address this issue, the present disclosure provides an intelligent cockpit interaction method, device, and system. In an aspect of the present disclosure, a first agent and at least one second agent are configured in an intelligent cockpit, and interaction with the intelligent cockpit is achieved through cooperation of the first agent and the second agent. Further, the interaction process does not need to use semantic templates for semantic understanding, and therefore, there is no need to develop corresponding semantic templates for different voice requests, which can reduce costs.

### Exemplary System

Embodiments of the present disclosure provide an intelligent cockpit interaction method, device, and system that may enable interaction with a user according to the scheme provided by embodiments of the present disclosure.

In one possible implementation, the electronic apparatus to which embodiments of the present disclosure are applied is an intelligent cockpit. Illustratively, the intelligent cockpit may be provided within a vehicle, in which case the intelligent cockpit may enable interaction with a user of the vehicle.

Further, the intelligent cockpit may include audio collection means, such as a microphone or an array of microphones or the like, by means of which a voice request from the user can be collected.

Here, referring to the example shown in FIG. 1, the intelligent cockpit includes a first agent 001 and at least one second agent 002.

During the interaction process, the first agent 001 can acquire a first interaction request, determine a target agent for processing the first interaction request from among at least one second agent 002, and then send first request information corresponding to the first interaction request to the target agent. After receiving the first request information, the target agent may perform an operation corresponding to the first request information so as to realize the interaction of the intelligent cockpit.

An agent is a system that can perceive the environment autonomously, make decisions and perform actions, and has the basic characteristics of autonomy, interactivity, reactivity and adaptability. In the present disclosure, the first agent 001 and the second agent 002 may be software modules provided in the intelligent cockpit and may be performed by a processor of the intelligent cockpit. Further, it can be seen from the above-mentioned description of the first agent 001 that the first agent 001 can distribute the first request information to a corresponding target agent, namely, the first agent 001 has a distribution function, and therefore the first agent 001 can also be referred to as a distribution agent.

In addition, the second agent 002 may perform an operation corresponding to the first request information by calling an external application programming interface (API). Also, different second agents 002 may typically perform different operations.

Illustratively, the second agent 002 in the intelligent cockpit may include a navigation planning agent that may perform navigation operations by calling an API of a navigation application and/or a hotel restaurant agent that may call an API of a reservation application that reserves hotels and restaurants to achieve reservations for the hotels and restaurants.

Of course, the above description is only an exemplary description of the second agent provided in the intelligent cockpit, and other forms of the second agent may also be provided in the intelligent cockpit in practical applications, and the present disclosure is not limited thereto.

Further, in the present disclosure, the first agent 001 may also acquire a second interaction request, and send second request information corresponding to the second interaction request to the remote agent 003, and the remote agent 003 performs an operation corresponding to the second request information so as to satisfy the diversified interaction demands.

Illustratively, if the second agent 002 in the intelligent cockpit crashes, or the first agent 001 obtains an interaction request that the second agent 002 cannot perform, the operation corresponding to the interaction request can be performed by the remote agent 003.

In the process of realizing the intelligent cockpit interaction between the first agent and the second agent, there is no need to use semantic templates for semantic understanding, so there is no need to develop the corresponding semantic templates for various voice requests, which reduces the investment of developers and thus reduces the cost.

### Exemplary Method

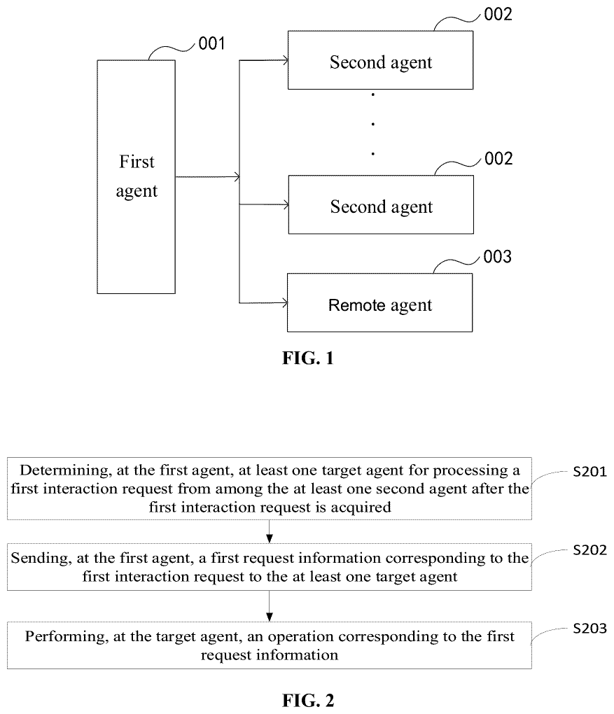

FIG. 2 is an intelligent cockpit interaction method provided by an exemplary embodiment of the present disclosure, which may be applied to an intelligent cockpit including a first agent and at least one second agent. As shown in FIG. 2, the method includes the following steps.

Step S201, determining, at the first agent, at least one target agent for processing a first interaction request from among the at least one second agent after the first interaction request is acquired.

In one possible implementation, the first interaction request includes a voice request. When the user wishes the intelligent cockpit to perform a certain operation, a corresponding voice request can be emitted, for example, when the user wishes the vehicle to open the window, a voice request of “opening the window” can be emitted, which is a first interaction request; when the user wishes the vehicle to travel to location A, a voice request of “navigating to location A” may be emitted, which is the first interaction request.

In another possible implementation, the first interaction request includes a request triggered by the target event of the intelligent cockpit. The target event may include a user operation received by the intelligent cockpit and/or an event sensed by the intelligent cockpit.

In one example, the target event includes a user operation received by the intelligent cockpit, and in this example, the intelligent cockpit may provide a touch control screen, which provides a plurality of touch control menus, wherein different touch control menus correspond to different functions, and the user operation may include a touch control operation for the touch control menu. In this case, after receiving a touch control operation for a certain touch control menu, the intelligent cockpit may determine a first interaction request based on a function corresponding to the touch control menu.

In another example, the target event includes an event sensed by the intelligent cockpit. In this example, a vehicle configured with the intelligent cockpit is undercharged, and the event may be an event that the intelligent cockpit senses an undercharge. In this case, upon sensing the undercharge, the intelligent cockpit may determine a first interaction request based thereon.

Alternatively, in another possible implementation, the first interaction request may include both the request triggered by the target event of the intelligent cockpit and the voice request. Of course, the first interaction request may also include other forms of requests, and the present disclosure is not limited thereto.

Step S202, sending, at the first agent, a first request information corresponding to the first interaction request to the at least one target agent.

In the present disclosure, a first agent may send first request information corresponding to a first interaction request to a target agent among second agents, that is to say, the first agent may function to distribute the first request information, and in this case, the first agent may also be referred to as a distribution agent.

Step 203, performing, at the target agent, an operation corresponding to the first request information.

In the disclosed embodiment, after receiving the first request information, the target agent may perform an operation corresponding to the first request information by calling an external application programming interface (API), so as to satisfy the interaction demands.

Illustratively, the first interaction request may include a voice request of “opening the window”, in which case the target agent, upon receiving the first request information, may call an API to open the window to cause the window to be opened.

In another example, the first interaction request may include a voice request of “navigating to location A”, in which case the target agent, after receiving the first request information, may call an API of a navigation application, through which navigation information for navigating to location A is determined, including information such as a route and real-time road conditions.

Alternatively, in another example, the first interaction request includes an interaction request generated after the intelligent cockpit senses an event of an undercharge, in which case, after receiving the first request information, the target agent may call an API for generating a charging prompt so as to prompt the user to charge in time through the generated charging prompt.

According to the scheme provided by the embodiments of the present disclosure, the first agent can distribute the first request information corresponding to the first interaction request to the target agent among the second agents, and then the target agent performs an operation corresponding to the first request information to achieve the interaction. Moreover, the interaction process does not need to utilize semantic templates for semantic understanding, and thus does not need to develop the corresponding semantic templates for various voice requests, which reduces the cost.

Further, in the schemes provided by embodiments of the present disclosure, the second agents may include one or more agents, and each of the second agents may perform a corresponding function. If the interaction demand increases, it is sufficient to reconfigure the corresponding second agent for the intelligent cockpit, and therefore, the scheme provided by the embodiments of the present disclosure has a better scalability, can be applied to a variety of interaction scenarios, and meets the diversified demand of users.

In addition, in current schemes, the intelligent cockpit is typically only able to interact based on voice requests. However, in the embodiments of the present disclosure, the first interaction request may include a voice request and/or a request triggered by a target event of the intelligent cockpit. Wherein if the first interaction request includes a voice request and a request triggered by the target event of the intelligent cockpit, the intelligent cockpit can perform the interaction both when the voice request is received and when the request is triggered by the target event. Thus, the embodiments of the present disclosure provide for a broader range of applications.

In the actual interaction process, the operation corresponding to the first interaction request may only need to be performed by one second agent. In this case, the target agent is one. And after determining the target agent, the first agent sends first interaction request information corresponding to the first interaction request to the target agent, so that the target agent performs corresponding operations.

For example, the operation corresponding to the first interaction request is to open the window, and one of the second agents can perform the operation of opening the window, then after the first agent acquires the first interaction request, the first request information corresponding to the first interaction request can be sent to the second agent, so that the second agent performs the operation of opening the window.

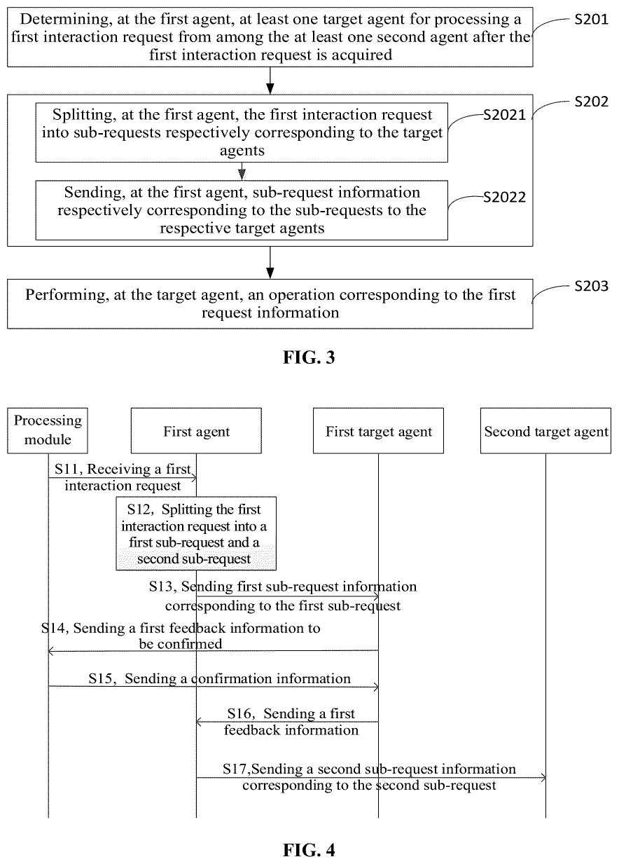

However, in some cases, the operation to which the first interaction request corresponds may require at least two second agents to perform, i.e. the target agent includes at least two. In this case, referring to the schematic diagram shown in FIG. 3, the step S202 of sending, by the first agent, a first request information corresponding to the first interaction request to the at least one target agent may include the following steps.

Step S2021, in response to that the at least one target agent comprises two or more target agents, splitting, at the first agent, the first interaction request into sub-requests respectively corresponding to the target agents.

In an embodiment of the present disclosure, different second agents may perform different operations corresponding to the different request information to meet different interaction demands. Therefore, in this step, the first agent splits the first interaction request according to the operations supported by each target agent, so that split sub-requests correspond to respective target agents.

In a possible splitting method, the sub-requests and the target agents can be in a one-to-one relationship, namely, one sub-request corresponds to one target agent; in this case, if n target agents are included, the first agent can split the first interaction request into n pieces, wherein n is a positive integer.

Illustratively, the first interaction request is “I want to go to Nanjing on business, initiate navigation, and reserve hotels tonight”, while one of the second agents in the intelligent cockpit is a navigation planning agent that calls the application programming interface (API) of the navigation application to determine navigation information through the navigation application, and the other second agent is a hotel restaurant agent that calls the API of the reservation application reserving the hotel restaurant through which information for the hotel and restaurant is queried for reservation. In this case, the above-mentioned two second agents are both target agents, and the first interaction request can be split into two sub-requests, one sub-request being “I want to go to Nanjing on business, initiate navigation”, and the target agent corresponding to the sub-request being a navigation planning agent, and the other sub-request being “reserving hotels tonight”, and the target agent corresponding to the sub-request being a hotel restaurant agent.

In another possible split mode, the sub-request and target agent may include a one-to-one and many-to-one relationship, i.e. one or at least two sub-requests correspond to a target agent.

Illustratively, the first interaction request is a voice request that “I want to go to Nanjing on business, initiate navigation, and reserve hotels and restaurants tonight”, and one of the second agents is a navigation planning agent and the other second agent is a hotel restaurant agent, the first interaction request can be split into three sub-requests, the first sub-request is “I want to go to Nanjing on business, initiate navigation”, and the first sub-request corresponds to the navigation planning agent; the second sub-request and the third sub-request are “reserve hotels tonight” and “reserve restaurants tonight”, respectively, and the second sub-request and the third sub-request each correspond to a hotel restaurant agent. Alternatively, in this example, the first interaction request described above may be split into two sub-requests, one sub-request being “I want to go to Nanjing on business, initiate navigation”, and the target agent corresponding to that sub-request being a navigation planning agent, and another sub-request being “reserve hotels and restaurants tonight”, and the target agent corresponding to that sub-request being a hotel restaurant agent.

Of course, in the present disclosure, it is also possible to split the first interaction request in other ways, as long as the split enables the sub-request obtained after splitting to be implemented by a second agent.

Step S2022, sending, at the first agent, sub-request information respectively corresponding to the sub-requests to the respective target agents. . . . That is, the first request information may be a set including at least one piece of sub-request information.

For example, in the above-mentioned example, if the first sub-request corresponds to the navigation planning agent, the first sub-request information corresponding to the first sub-request may be sent to the navigation planning agent; the second sub-request and the third sub-request both correspond to a hotel restaurant agent, and the second sub-request information corresponding to the second sub-request and the third sub-request information corresponding to the third sub-request can both be sent to the hotel restaurant agent.

After receiving the first request information, the target agent performs a corresponding operation according to the received first request information, so as to realize the interaction of the intelligent cockpit.

With the scheme of the embodiments of the present disclosure, in the case where the target agent includes two or more, the first interaction request can be split into corresponding sub-requests, so that each target agent realizes the function corresponding to the corresponding sub-request, and satisfies the interaction demands. If the target agent includes at least two, it tends to indicate that the first interaction request requires more operations to be performed, and based on the scheme of the embodiment of the present disclosure, the interaction of the intelligent cockpit can still be realized in this case, so as to satisfy the user's diverse interaction demands.

Through the operation of step S2022, the first agent can respectively send the sub-request information corresponding to the sub-requests to the corresponding target agents, and this operation can be achieved in a variety of ways.

In one possible implementation, this operation may include the following steps.
sending, at the first agent, sub-request information respectively corresponding to the sub-requests to the respective target agents within a target duration range.

The time when the first agent sends the sub-request information for the first time can be taken as a starting time, timing is started from the starting time, and the operation of sending the sub-request information corresponding to the sub-requests to respective target agents is completed within the range of the target duration range. The target duration range is a pre-set duration range, which can also be adjusted according to the interaction demands during the interaction. Illustratively, the target duration range may be 0 to 10 milliseconds, although other ranges may be used, and the present disclosure is not limited thereto.

With this implementation, the sub-request information corresponding to sub-requests can be sent to the respective target agents within the target duration range. Wherein the target duration range can be set as a shorter duration range; in this case, the first agent can send sub-request information corresponding to sub-requests to a respective target agents within a shorter duration (for example, at the same time or near the same time), so as to facilitate different target agents to receive corresponding first request information as soon as possible, thereby enabling each target agent to perform corresponding operations as soon as possible, reducing the time spent in the whole interaction process, and improving the efficiency of interaction.

If the target agent does not need to generate feedback information that needs to be confirmed in the process of performing the operation corresponding to the first request information, the above-mentioned implementation is usually adopted.

In the present disclosure, part of the target agent generates feedback information that needs to be confirmed during the operation corresponding to the first request information, and can continue to perform subsequent operations after receiving the confirmation information for the feedback information. Illustratively, the navigation planning agent determines a plurality of paths according to the destination indicated in the first request information during the navigation process, and the navigation planning agent needs to determine which path to implement path planning according to, in this case, the feedback information that needs to be confirmed is information including the plurality of paths, and the confirmation information for the feedback information is information for indicating one of the paths.

And another part of the target agents can complete an operation corresponding to the first request information on their own after receiving the first request information, and no feedback information that needs to be confirmed is generated during the operation. Illustratively, the first interaction request includes a voice request of “closing the window and turn on the air conditioner”, the first agent splits the first interaction request into two sub-requests, respectively being “closing the window” and “turn on the air conditioner”, the second agent corresponding to the first sub-request is a window control agent, and the second agent corresponding to the second sub-request is an air conditioner control agent. Since neither the window control agent nor the air conditioner control agent generates feedback information that needs to be confirmed in the operation process, and there is no case where different agents interfere with each other in the process of sending the feedback information and receiving confirmation information corresponding to the feedback information, the first agent can send sub-request information corresponding to the first sub-request to the window control agent so that the window control agent closes the window, and send sub-request information corresponding to the second sub-request to the air conditioner control agent so that the air conditioner control agent turns on the air conditioner within the target duration range.

In this example, since the first agent sends corresponding first request information to the window control agent and the air conditioner control agent respectively within the target duration range, it is helpful for the window control agent and the air conditioner control agent to receive the corresponding first request information as soon as possible, and accordingly, the speed of closing the window and turning on the air conditioner can be improved, and the interaction efficiency can be improved.

Alternatively, in another possible implementation, an operation of a first agent respectively sending sub-request information corresponding to a sub-request to a corresponding target agent may include the following steps.

First, sending, at the first agent, first sub-request information corresponding to a first sub-request among the sub-requests to a first target agent.

Then, if the first target agent satisfies a first condition, sending, at the first agent, second sub-request information corresponding to a second sub-request among the sub-requests to a second target agent.

In this implementation, the first sub-request and the second sub-request are two different sub-requests. Illustratively, the first sub-request may be any one of the respective sub-requests, and the second sub-request may be any one of the other sub-requests other than the first sub-request.

Alternatively, in another example, the first sub-request and the second sub-request may be determined based on the location of the respective sub-request in the first interaction request, typically with the location of the first sub-request preceding the location of the second sub-request. For example, the first interaction request includes a voice request of “closing the window, turning on the air conditioner”, in which the “closing the window” precedes the “turning on the air conditioner”, so that the “closing the window” is the first sub-request and the “turning on the air conditioner” is the second sub-request.

Through this operation, the sub-request information corresponding to the sub-request located at the previous position in the first interaction request can be preferentially sent to the corresponding target agent, so that the target agent preferentially performs the operation corresponding to this sub-request. If the first interaction request includes a user's voice request, the user' s body sensation itself is preferentially performed compared to the operation corresponding to the sub-request sent earlier, so that the user's experience can be improved.

Of course, in the present disclosure, the first sub-request and the second sub-request of the respective sub-requests may also be determined in other ways, and the present disclosure is not limited thereto.

In this implementation, the first sub-request corresponds to a first target agent, and the second sub-request corresponds to a second target agent, and the first agent first sends first sub-request information corresponding to the first sub-request to the first target agent, and after determining that the first target agent satisfies the first condition, sends second sub-request information corresponding to the second sub-request to the corresponding second target agent.

With this implementation, the first target agent and the second target agent can perform corresponding operations in sequence, so as to reduce the interference caused to each other when multiple target agents perform corresponding operations at the same time, and improve the accuracy of intelligent cockpit interaction.

If a certain target agent generates feedback information that needs to be confirmed in the process of performing an operation corresponding to first request information, the target agent will send the feedback information. Based on the feedback information, the intelligent cockpit may send the corresponding confirmation information to the target agent so that the target agent obtains the confirmation information for the feedback information. In this case, the above-described implementation can be adopted to avoid interfering with each other when different target agents perform operations at the same time, and reduce the possibility that the feedback information or the confirmation information of the feedback information is lost during the sending process, thereby improving the accuracy of intelligent cockpit interaction.

The intelligent cockpit may determine the confirmation information corresponding to the feedback information by the following means: in the first possible implementation, after receiving the feedback information, the intelligent cockpit can directly generate corresponding confirmation information according to the feedback information, and then send the confirmation information to the target agent; in a second possible implementation, after receiving the feedback information, the intelligent cockpit may display the feedback information for the user to view, and receive a corresponding operation of the user, then generate corresponding confirmation information according to the received operation of the user, and then send the confirmation information to the target agent;

In the present disclosure, the intelligent cockpit includes not only the first agent and the second agent, but also a processing module that can perform the above-described operation of generating corresponding confirmation information directly based on the feedback information. In addition, the processing module may push the feedback information to a display device (e.g. an instrument panel and/or a head-up display, etc.) of the intelligent cockpit after receiving the feedback information, so that the display device displays the feedback information, and the processing module may generate corresponding confirmation information according to the received user operation, and then send the confirmation information to the target agent.

In one possible implementation, the first agent, the second agent, and the processing module may be run by the same processor of the intelligent cockpit. Alternatively, in another possible implementation, the first agent, the second agent, and the processing module may each be operated by different processors of the intelligent cockpit, and the disclosed embodiments are not limited thereto.

Illustratively, the first interaction request is a voice request that “I want to go to Nanjing on business, initiate navigation, and reserve hotels tonight”, the first sub-request is “I want to go to Nanjing on business, initiate navigation”, the first target agent is a navigation planning agent, while the second sub-request is “reserve hotels tonight”, and the second target agent is a hotel restaurant agent. In this case, after receiving the first sub-request information corresponding to the first sub-request, the first target agent calls the API of the navigation application to acquire a plurality of paths planned by the navigation application, and then the first target agent needs the user to select one path from the plurality of paths so as to navigate the user according to the path selected by the user, so that the feedback information generated by the first target agent that needs to be confirmed includes information about the plurality of paths, and the user needs to confirm one of the paths.

In this example, after the first target agent generates the feedback information that needs to be confirmed, the confirmation information for the feedback information needs to be acquired, and then subsequent operations can be continued. In this case, if the first agent does not wait for the first target agent to satisfy the first condition, sending the second sub-request information corresponding to the second sub-request to the second target agent may cause the first target agent and the second target agent to perform operations at the same time, which may cause interference between the feedback information or the confirmation information of the feedback information and the second sub-request information during the sending process, causing the feedback information or the confirmation information to be lost during the sending process, or causing the second target agent to be unable to receive the second sub-request information. Therefore, the first agent can send the sub-request information corresponding to the second sub-request to the second target agent after determining that the first target agent satisfies the first condition, so as to reduce the interference between the two target agents and improve the accuracy of interaction.

In the above-mentioned embodiment, an operation is provided for the first agent to send the second sub-request information to the corresponding second target agent after determining that the first target agent satisfies the first condition. The first condition is described by way of the following embodiment.

In a possible implementation, if the first target agent sends first feedback information about successful operation to the first agent after completing the operation corresponding to the first request information, the first condition includes: the first agent receiving the first feedback information.

In this implementation, after completing the operation corresponding to the first request information, the first target agent sends first feedback information of which the operation is successful to the first agent; therefore, if the first agent receives the first feedback information, it indicates that the first target agent has completed the operation corresponding to the first request information; in this case, if the first agent sends the second sub-request information to the second target agent, it will not cause interference; therefore, the first agent can determine that the first target agent satisfies the first condition in the case of receiving the first feedback information.

In order to clarify the implementation, the interaction schematic diagram shown in FIG. 4 is disclosed. Referring to FIG. 4, a schematic diagram includes a first agent, a first target agent, and a second target agent. In this interaction process, the following steps are included.

Step S11, receiving, at the first agent, a first interaction request.

The first interaction request may include a voice request emitted by a user, and/or a request triggered by a target event of the intelligent cockpit.

Step S12, splitting, at the first agent, the first interaction request, to obtain a first sub-request and a second sub-request after receiving the first interaction request. And, the first agent determines that the first sub-request corresponds to the first target agent, and that the second sub-request corresponds to the second target agent.

Step S13, sending, at the first agent, first sub-request information corresponding to the first sub-request to a corresponding first target agent.

Taking the above example as an example, the first interaction request is a voice request that “I want to go to Nanjing on business, initiate navigation, and reserve hotels tonight”, and the first sub-request is “I want to go to Nanjing on business, initiate navigation”, the corresponding first target agent is a navigation planning agent, while the second sub-request is “reserve hotels tonight”, and the corresponding second target agent is a hotel restaurant agent. In this step, the first agent sends the sub-request information corresponding to the sub-request that “I want to go to Nanjing on business, initiate navigation” to the navigation planning agent.

Step S14, performing, at the first target agent, a corresponding operation after receiving the first sub-request information corresponding to the first sub-request. In performing the operation, the first target agent generates feedback information that needs to be confirmed and sends the feedback information that needs to be confirmed to a processing module in the intelligent cockpit.

After receiving the feedback information that needs to be confirmed, the processing module in the intelligent cockpit can directly generate corresponding confirmation information according to the feedback information, and then send the confirmation information to the target agent; alternatively, after receiving the feedback information, a processing module in the intelligent cockpit may call a display device of the intelligent cockpit to display the feedback information so as to be viewed by a user, and after receiving a corresponding operation of the user, the processing module generates corresponding confirmation information according to the received operation of the user, and then sends the confirmation information to the target agent so that the target agent acquires the confirmation for the feedback information.

Continuing with the above example, after receiving the first sub-request information corresponding to the first sub-request, the first target agent calls the API of the navigation application to obtain a plurality of paths to Nanjing planned by the navigation application, and then the first target agent requires the user to select one path from the plurality of paths so as to provide navigation for the user according to the path selected by the user. Therefore, the feedback information that needs to be confirmed generated by the first target agent includes information on a plurality of paths, and the feedback information is sent to a processing module in the intelligent cockpit.

After receiving the feedback information, a processing module in the intelligent cockpit can push the feedback information to a display device, and the display device displays information on multiple paths included therein for a user to select, and after viewing the displayed information on the multiple paths, the user can select one of the paths according to the demands thereof; then, the processing module in the intelligent cockpit generates corresponding confirmation information according to the received user operation, wherein the confirmation information is used for indicating the path selected by the user, and then sends the confirmation information to the first target agent.

Step S15, sending, at the processing module in the intelligent cockpit, a confirmation information to the first target agent. After receiving the confirmation information, the first target agent continues to perform the operation corresponding to the first sub-request information corresponding to the first sub-request according to the confirmation information.

Step S16, after completing the operation, sending, at the first target agent, first feedback information for indicating that the operation of the first target agent is successful to the first agent.

Continuing with the above example, the confirmation information received by the first target agent is used to indicate a path to Nanjing, and after receiving the confirmation information, the first target agent determines navigation information on the path indicated by the confirmation information by calling API of the navigation application, and feeds back the navigation information to the intelligent cockpit. After receiving the navigation information, the intelligent cockpit can display the navigation information so that the user can drive the vehicle according to the navigation information.

In addition, after feeding back the navigation information, the first target agent generally considers itself to have successfully completed the operation, and then sends the first feedback information to the first agent.

Step S17, after receiving the first feedback information, sending, at the first agent, second sub-request information corresponding to the second sub-request to a corresponding second target agent so that the second target agent performs a corresponding operation according to the received first request information.

If the first agent receives the first feedback information, it is indicated that the first target agent has successfully completed the operation, and in this case, the first agent sends the second sub-request information corresponding to the second sub-request to the corresponding second target agent, thereby enabling the first target agent and the second target agent to perform the operation successively, so as to avoid the two target agents performing the operation at the same time; accordingly, it can also avoid causing interference to each other when different target agents perform the operation at the same time, and reduce the possibility that the feedback information or the confirmation information on the feedback information is lost during the sending process; therefore, the accuracy of intelligent cockpit interaction is improved.

In another possible implementation of the present disclosure, if the first target agent enters a listening state after feeding back the second feedback information to be confirmed in the process of performing an operation corresponding to the first request information, the first condition includes: the first target agent being in a state other than a working state and a listening state for waiting for confirmation of the second feedback information.

In this implementation, the first agent periodically detects the state of the first target agent after sending the first sub-request information corresponding to the first sub-request to the first target agent, and when it is detected that the first target agent is in a state other than the working state and the listening state, the first agent can determine that the first target agent satisfies the first condition.

In addition, in this implementation, the state of the first target agent can be divided into the following three types: a working state, a listening state, and a state other than the working state and the listening state.

The working state refers to a state where the first target agent is performing a corresponding operation. For example, the first target agent in a listening state does not work, but waits for confirmation of the second feedback information; after receiving confirmation information corresponding to the second feedback information, the first target agent can adjust from the listening state to a working state, and continues to perform a corresponding operation based on the confirmation information corresponding to the second feedback information. In addition, if the first target agent is in a state other than the working state and the listening state, it is indicated that the first target agent has not performed an operation, and does not wait for confirmation of the second feedback information. Generally, if the first target agent is in the state, it can be considered that the first target agent has not performed an operation, or the first target agent has completed an operation that the first target agent needs to perform itself.

In this case, after sending first sub-request information corresponding to the first sub-request to the first target agent, if it is detected that the first target agent is in a working state, it is indicated that the first target agent is performing an operation corresponding to the first request information; if it is detected that the first target agent is in a listening state, it is indicated that the first target agent is waiting for confirmation information regarding the second feedback information, so as to continue to perform a corresponding operation after receiving the confirmation information; in addition, if it is detected that the first target agent is in a state other than the working state and the listening state, it is indicated that the first target agent has completed the operation corresponding to the first request information.

Therefore, after detecting that the first target agent is in a state other than the working state and the listening state, the first agent sends the second sub-request information corresponding to the second sub-request to the corresponding second target agent, which can avoid the first target agent and the second target agent performing operations at the same time, reduce the interference between different target agents, and improve the accuracy of interaction.

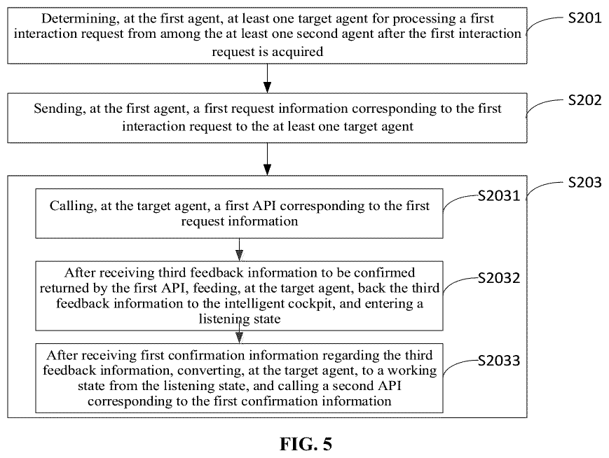

In order to clarify the state of the target agent, the process of the target agent performing an operation corresponding to the first request information will be described below. With reference to the work flow schematic diagram shown in FIG. 5, the target agent performing an operation corresponding to the first request information includes the following steps.

Step S2031, calling, at the target agent, a first application programming interface (API) corresponding to the first request information.

Step S2032, after receiving third feedback information to be confirmed returned by the first API, feeding, at the target agent, back the third feedback information to the intelligent cockpit, and entering a listening state.

That is, after feeding back the third feedback information to the intelligent cockpit, the target agent transitions from the working state to the listening state.

After receiving the third feedback information, the intelligent cockpit may directly generate the first confirmation information corresponding to the third feedback information, or the intelligent cockpit may generate the first confirmation information according to the received user operation. After generating the first confirmation information, the intelligent cockpit will send the first confirmation information to the target agent.

Step S2033, after receiving first confirmation information regarding the third feedback information, converting, at the target agent, to a working state from the listening state, and calling a second API corresponding to the first confirmation information so as to perform an operation corresponding to the first confirmation information via the second API.

The first API and the second API may be the same API or may be different API, and the present disclosure is not limited thereto.

Illustratively, if the first request information is information requesting navigation, then the target agent is a navigation planning agent, and the first API is an API of a navigation application, the third feedback information received by the target agent includes information about a plurality of paths, and the first confirmation information is used for indicating one of the paths. In this case, the second API is an API of the navigation application, and after acquiring the first confirmation information, the target agent can acquire path information planned by the navigation application based on the first confirmation information by calling the second API so as to achieve navigation.

In addition, after the target agent performs an operation corresponding to the first information confirmation information via the second API, if no other operations need to be performed, the target agent transitions from the working state to a state other than the working state and the listening state.

It can be seen therefrom that the target agent can perform an operation corresponding to the first request information by calling the API so as to realize an interaction function. And the target agent is in a working state during the operation process; after sending the third feedback information to be confirmed, the target agent needs to wait for the first confirmation information regarding the third feedback information, and in this case, the target agent switches from a working state to a listening state; after receiving the first confirmation information, the target agent switches from a listening state to a working state, and continues to perform a corresponding operation; after completing the operation corresponding to the first request information, the target agent transitions from the working state to a state other than the working state and the listening state.

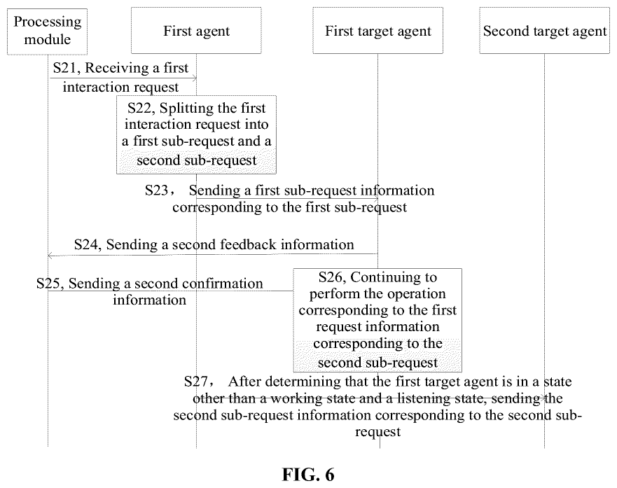

In conjunction with the above-mentioned description of the process of performing an operation corresponding to the first request information with regard to the target agent, in order to clarify that the first condition includes an implementation process of the first target agent being in a state other than the working state and the listening state, the interaction schematic diagram shown in FIG. 6 is disclosed.

Referring to FIG. 6, a schematic diagram includes a first agent, a first target agent, and a second target agent. In this interaction process, the following steps are included.

Step S21, receiving, at the first agent, a first interaction request.

Step S22, splitting, at the first agent, the first interaction request, to obtain a first sub-request and a second sub-request after receiving the first interaction request. And, the first agent determines that the first sub-request corresponds to the first target agent, and that the second sub-request corresponds to the second target agent.

Step S23, sending, at the first agent, first sub-request information corresponding to the first sub-request to a corresponding first target agent.

Here, the operations of steps S21 to S23 are the same as the operations of steps S11 to S13 and may be referred to each other, and the description thereof will not be repeated here.

Step S24, performing, at the first target agent, a corresponding operation after receiving the first sub-request information corresponding to the first sub-request. In performing the operation, the first target agent may call the API corresponding to the first request information, and the first target agent may generate second feedback information that needs to be confirmed, and then send the second feedback information to the processing module in the intelligent cockpit. And, after transmitting the second feedback information, the first target agent transitions from the working state to the listening state.

In addition, after receiving the second feedback information, the processing module in the intelligent cockpit can directly generate second confirmation information corresponding to the second feedback information, and then send the second confirmation information to the first target agent; or after receiving the second feedback information, the processing module in the intelligent cockpit can push the second feedback information to a display device of the intelligent cockpit to display by the display device for a user to view; and after receiving a corresponding operation of the user, the processing module generates corresponding second confirmation information according to the received operation of the user; and then send the second confirmation information to the target agent.

Further, through this process, the first target agent can directly send the second feedback information to the intelligent cockpit without passing through the first agent, which helps to improve the speed of acquiring the second feedback information by the intelligent cockpit and further improves the interaction efficiency.

Step S25, sending, at the processing module in the intelligent cockpit, a second confirmation information to the first target agent.

Step S26, after receiving the second confirmation information, switching, at the first target agent, from a listening state to a working state, and continuing to perform an operation, which is performed by calling a corresponding API, corresponding to the second sub-request information corresponding to the second sub-request according to the second confirmation information.

In addition, after the first target agent completes the operation, the first target agent transitions from the working state to a state other than the working state and the listening state.

Step S27, after determining that the first target agent is in a state other than the working state and the listening state, sending, at the first agent, the second sub-request information corresponding to the second sub-request to the corresponding second target agent, so that the second target agent performs a corresponding operation according to the received first request information.

In this step, the first agent may periodically detect the status of the first target agent. If it is detected at a certain period that the first target agent is in a working state or a listening state, the first agent does not send the second sub-request information corresponding to the second sub-request to the second target agent, and the periodic detection is continued until the first agent detects that the first target agent is in a state other than the working state and the listening state, the first agent sends the second sub-request information corresponding to the second sub-request to the second target agent again, and terminate the detection of the state of the first target agent.

In this implementation, after determining that the first target agent is in a state other than the working state and the listening state, the first agent sends second sub-request information corresponding to the second sub-request to the corresponding second target agent, so that the first target agent and the second target agent can perform operations in sequence, and interference caused to each other when the two target agents perform operations at the same time can be avoided, so that the accuracy of intelligent cockpit interaction can be improved.

In the above-mentioned two implementations, it is respectively described that the first condition includes an implementation in which the first agent receives the first feedback information, and that the first condition includes an implementation in which the first target agent is in a state other than the working state and the listening state. In a practical scenario, the first condition may also include that the first agent receives the first feedback information, as well as that the first target agent is in a state other than the working state and the listening state, and the present disclosure is not limited thereto.

In the scheme provided by the present disclosure, a first agent needs to acquire a first interaction request, wherein the first interaction request includes: a voice request and/or a request triggered by a target event of an intelligent cockpit.

If the first interaction request includes a voice request, the first request information corresponding to the first interaction request includes: a text request converted by the first agent from the voice request via a first large language model (LLM), and/or the voice request.

In the disclosed embodiment, if the first interaction request includes a voice request, the first request information corresponding to the first interaction may include the voice request, and in this case, after receiving the voice request, the first agent sends the voice request to the corresponding target agent, and in this process, the first agent is not required to process the voice request, and therefore the target agent is more efficient in acquiring the first interaction request.

Additionally, a first LLM may be provided in the first agent, or the first LLM may be independent of the first agent, and the first agent may have access to the first LLM. In this case, after receiving the voice request, the first agent may convert the voice request into a corresponding text request through the first LLM, and send the text request to the target agent, so that the target agent performs an operation corresponding to the text request.

LLM is generally trained by a large amount of text data, can understand the complexity and nuances of natural languages, and can recognize voice requests by combining the context of interaction history and the voice requests received this time, and can support multiple languages, i.e. have a strong general knowledge ability. Therefore, the voice request can be converted into the corresponding text request through the large language model, which can improve the accuracy of the text request, and even if a relatively complex voice request is received, a better interaction effect can be achieved.

In the current intelligent cockpit interaction technology, the voice request is usually recognized by voice model. Since the accuracy of speech recognition by a speech model is lower than that of LLM, and semantic templates are not required in the process of converting a voice request into a text request by LLM, the embodiments of the present disclosure provide a scheme for recognizing a voice request with higher accuracy than the current technology, and accordingly can improve the accuracy of intelligent cockpit interaction.

In addition, if the first interaction request includes a request triggered by the target event of the intelligent cockpit, the first request information corresponding to the first interaction request includes: a text request and/or the voice request determined by the first agent according to a request generated under the trigger by the target event of the intelligent cockpit, so that the target agent performs a corresponding operation according to the text request.

In current intelligent cockpit interaction technology, the interaction of intelligent cockpit can only be performed according to the received voice request. However, in the disclosed embodiment, the intelligent cockpit may also generate a first interaction request upon the trigger of the target event, and the first agent may send the text request and/or voice request determined by the request generated under the trigger of the target event to the target intelligent agent, thereby enabling the target intelligent agent to perform the corresponding operation. Thus, the schemes provided by embodiments of the present disclosure can be applied in more scenarios and has a wider range of applications compared with current technology.

In addition, in the above-described embodiment, an operation is provided in which the first agent sends a text request and/or a voice request to the target agent. Accordingly, the operation of the calling, at the target agent, a first application programming interface (API) corresponding to the first request information can be achieved by the following steps.
if the first interaction request comprises the text request, determining and calling, at the target agent, the first API corresponding to the text request, and/or.
if the first interaction request comprises the voice request, converting, at the target agent, the voice request into a corresponding text request via a second LLM, and determining and calling the first API corresponding to the text request.

A second LLM may be provided in the target agent, or the second LLM may be independent of the target agent, and the target agent may have access to the second LLM. In this case, after receiving a voice request, the target agent may convert the voice request into a corresponding text request through a second LLM, and then perform an operation corresponding to the text request. Since the second LLM recognizes the voice request more accurately, this scheme can further improve the accuracy of the intelligent cockpit interaction.

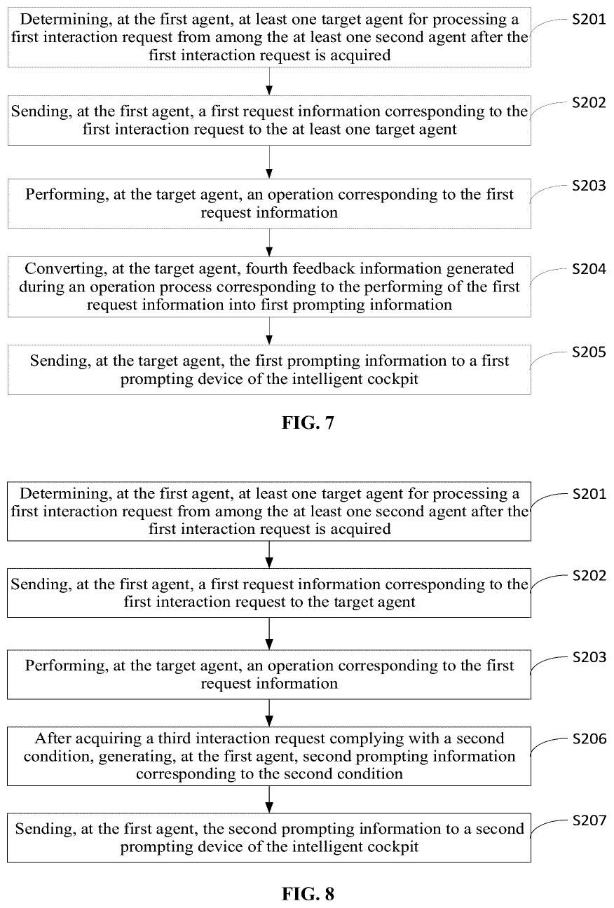

Referring to the work flow schematic diagram shown in FIG. 7, in another embodiment of the present disclosure, the method provided by an embodiment of the present disclosure further includes:

Step S204, converting, at the target agent, fourth feedback information generated during an operation process corresponding to the performing of the first request information into first prompting information.

The fourth feedback information generated during process of performing the operation corresponding to the first request information may include at least one of the following information: the completion prompting information after the operation is successfully completed, the failure prompting information that the operation cannot be completed and the intermediate result information during the operation process.

For example, if the first request information is used for open the window, after the target agent completes the operation of opening the window, completion prompting information indicating the successful opening of the window may be generated; if the first request information is for navigating the vehicle, the feedback information may include planning information of a path, the planning information of the path belonging to the intermediate result information.

Step S205, sending, at the target agent, the first prompting information to a first prompting device of the intelligent cockpit, so as to output the first prompting information via the first prompting device.

The first prompting device of the intelligent cockpit typically includes an audio output device, which may include a microphone, a microphone array and/or an audio sound etc., and/or a display device, which may include a dashboard and/or a head up display (HUD), etc. arranged in front of the driver's seat.

Accordingly, the first prompting information may include audio prompting information, image prompting information, and/or video prompting information. The audio prompting information may be output by an audio output device, and the image prompting information and/or the video prompting information may be displayed by a display device so as to act as a prompt to the user.

Through the steps described above provided by an embodiment of the present disclosure, the intelligent cockpit can output first prompting information through the first prompting device to prompt the user.

In the schemes provided by embodiments of the present disclosure, an intelligent cockpit may include at least one second agent, and different second agents may perform different functions to meet interaction demands. However, in some cases, the second agent fails to meet the interaction demands, for example, the second agent crashes, or each second agent fails to perform a function corresponding to the interaction request. To address this issue, the intelligent cockpit in embodiments of the present disclosure may also support interaction with remote agents in order to meet interaction demands through the remote agents.

In this case, in another embodiment of the present disclosure, the intelligent cockpit interaction method further includes the following steps.
after acquiring a second interaction request supported by the remote agent, sending, at the target agent, second request information corresponding to the second interaction request to the remote agent, so as to perform an operation corresponding to the second request information by the remote agent.

The second request information corresponding to the second interaction request may include a voice request, and/or a text information. Illustratively, the second interaction request includes a voice request, and after acquiring the voice request, the first agent may convert the voice request into a corresponding text request via the first LLM, which belongs to the second request information.

In addition, if the remote agent receives a voice request, the voice request can also be converted into a text request through LLM, and then the corresponding operation of the text request can be performed, so as to improve the accuracy of interaction.

With the scheme of the embodiments of the present disclosure, a corresponding operation can be realized using a remote agent, so that the interaction demand can be satisfied by the remote agent in the case where the interaction demand cannot be satisfied by the second agent, so as to satisfy a diversified interaction demand.

In the above-mentioned various embodiments, the operations of a first agent sending request information corresponding to a first interaction request to a target agent among a second agent and sending request information corresponding to a second interaction request to a remote agent are respectively introduced, and by means of the above-mentioned operations, the operations corresponding to the interaction request can be respectively performed by the target agent and the remote agent so as to satisfy interaction demands. However, in some cases, the first agent may receive an interaction request that cannot be distributed. In response to this situation, the present disclosure also provides another embodiment, see the work flow schematic diagram shown in FIG. 8, including the following steps.

Step S206, after acquiring a third interaction request complying with a second condition, generating, at the first agent, second prompting information corresponding to the second condition;

Step S207, sending, at the first agent, the second prompting information to a second prompting device of the intelligent cockpit, so as to prompt the second prompting information via the second prompting device.

In one possible implementation, the second condition includes: a function to be realized corresponding to the third interaction request being to set a function which is not supported by a vehicle provided with the intelligent cockpit, and/or the third interaction request being an interaction request which fails to be identified by the first agent.

According to the scheme provided by the embodiments of the present disclosure, if the first agent acquires the third interaction request complying with the second condition, the first agent no longer determines whether there is a corresponding target agent or remote agent, but directly generates corresponding second prompting information, so that the user can be prompted as soon as possible.

Illustratively, if the third interaction request indicates that the vehicle is taking off, the first agent, after receiving the third interaction request, may determine that the vehicle does not support the function, thereby generating corresponding prompting information and prompting by the second prompting device.

In addition, in the embodiments of the present disclosure, the second prompting device may be the same prompting device as the first prompting device, or may be a different prompting device, and the present disclosure is not limited thereto.

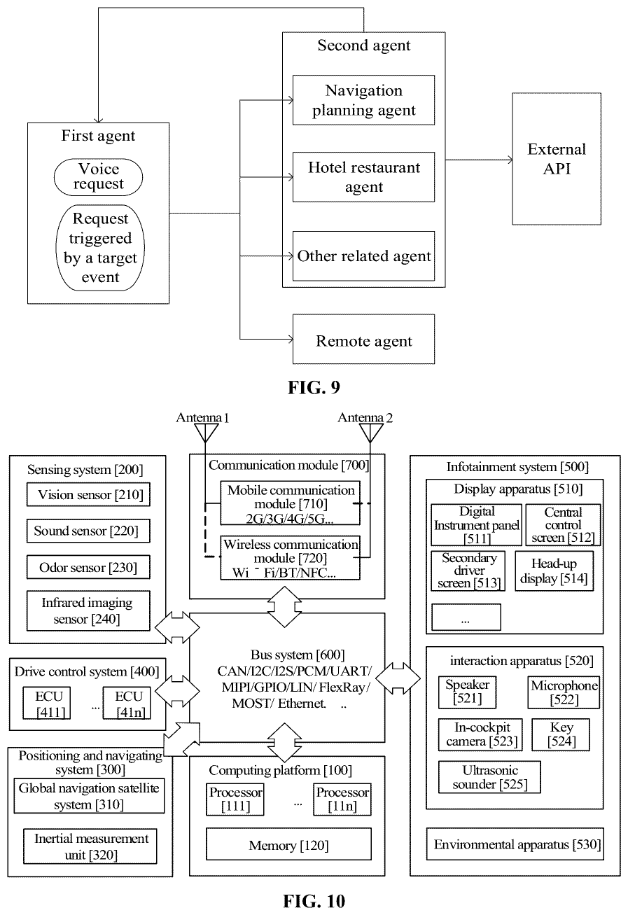

To clarify the intelligent cockpit interaction method provided by embodiments of the present disclosure, an example of the present disclosure is provided. Referring to FIG. 9, a schematic diagram of the architecture of an intelligent cockpit is shown. In this example, the intelligent cockpit includes a first agent and a plurality of second agents. Further, the first agent may also interact with a remote agent. The remote agent may typically be located at the cloud.

The first agent can receive a voice request sent by a user, and the first agent can also acquire a request triggered by a target event of the intelligent cockpit, and the voice request and/or the request triggered by the target event of the intelligent cockpit belong to a first interaction request, a second interaction request or a third interaction request.

After receiving the first interaction request, the first agent can determine a target agent corresponding to the first interaction request, and the target agent belongs to the second agent; then, the first agent sends the first request information corresponding to the first interaction request to the target agent, and the target agent performs an operation corresponding to the first request information. In addition, each of the second agents may generally perform a corresponding operation by calling an external API.

Referring to FIG. 9, in this example, the second agent includes: navigation planning agents, hotel restaurant agents, and other related agents. If the first interaction request is an interaction request relating to a navigation planning aspect, a navigation planning agent is a target agent, and the navigation planning agent can call an API of a navigation application; if the first interaction request relates to an interaction request for a reservation aspect of a hotel restaurant, then the hotel restaurant agent is a target agent, which may call an API of a reservation application for reserving the hotel restaurant. In addition, the other relevant agents can be used to perform other operations corresponding to the first interaction request by calling other API.

Of course, FIG. 9 is only one example provided by the present disclosure, and other types of second agents may also be provided in an actual interaction scenario, and the present disclosure is not limited thereto.

Further, if new interaction demands arise, additional second agents may be configured for the intelligent cockpit to meet the diverse interaction demands.

In addition, the second agent may also provide corresponding information feedback to the first agent. For example, upon successful completion of the operation, the second agent may send first feedback information to the first agent, and/or the second agent may send second feedback information to be confirmed to the first agent, etc.

After acquiring a second interaction request, the first agent may also send second request information corresponding to the second interaction request to the remote agent, so that the remote agent performs an operation corresponding to the second request information.

In the event that the second agent fails to satisfy the interaction demand (e.g. the second agent crashes, or the second agent fails to perform an operation corresponding to the second interaction request), the interaction demand may be satisfied by the remote agent.

In addition, after acquiring the third interaction request, the first agent no longer sends request information corresponding to the third interaction request to the second agent and the remote agent, but generates second prompting information so as to prompt the user via the second prompting information.

As can be seen from this example, the intelligent interaction provided by the present disclosure relies on the agent to effect the interaction without developing corresponding semantic templates for various voice requests, thus reducing development costs. Further, in the case of increased interaction demands, it is sufficient to reconfigure a corresponding second agent for an intelligent cockpit, and therefore, the scheme provided by the embodiments of the present disclosure has a better scalability, and can meet the diversified demands of users.

Further, the first agent, the second agent, and/or the remote agent may convert the received voice request into a text request via the LLM, and then perform subsequent operations. LLM has a strong general ability, which helps to improve the accuracy of interaction.

### Exemplary Mean 1

The following are device embodiments of the present disclosure that may be used to perform method embodiments of the present disclosure. For details not disclosed in the device embodiments of the present disclosure, reference is made to the method embodiments of the present disclosure.

FIG. 1 is a structure diagram of an intelligent cockpit interaction device provided by an exemplary embodiment of the present disclosure. The device may be provided in an intelligent cockpit, including:
a first agent, configured for determining at least one target agent for processing a first interaction request from among the at least one second agent after the first interaction request is acquired, and for sending a first request information corresponding to the first interaction request to the at least one target agent; and
the at least one target agent, configured for performing an operation corresponding to the first request information after receiving the first request information sent by the first agent.

In one possible implementation, the first agent specifically performs the following operations.
if the at least one target agent comprises two target agents or more, splitting, by the first agent, the first interaction request into sub-requests respectively corresponding to the target agents; and
sending, by the first agent, sub-request information corresponding to the sub-requests to the respective target agents.

The first agent can send the sub-request information corresponding to the sub-request in a plurality of ways. Illustratively, the sending, by the first agent, sub-request information corresponding to the sub-requests to the respective target agents, includes: sending, by the first agent, sub-request information corresponding to the sub-requests to the respective target agents within a target duration range.

Alternatively, in another example, the sending, by the first agent, sub-request information corresponding to the sub-requests to the respective target agents, includes: sending, by the first agent, first sub-request information corresponding to a first sub-request among the sub-requests to a first target agent; and after determining that the first target agent satisfies a first condition, the first agent sending second sub-request information corresponding to a second sub-request in the sub-requests to a corresponding second target agent.
the first condition comprises the first agent receiving first feedback information if the first target agent sends the first feedback information about successful operation to the first agent after completing the operation corresponding to the first request information; and/or
the first condition comprises the first target agent being in a state other than a working state and a listening state for waiting for confirmation of a second feedback information if the first target agent enters into the listening state after feeding back the second feedback information to be confirmed in the process of performing the operation corresponding to the first request information.

In the present disclosure, the first interaction request includes: a voice request and/or a request triggered by a target event of the intelligent cockpit.
if the first interaction request comprises a voice request, first request information corresponding to the first interaction request comprises: a text request converted by the first agent from the voice request via a first large language model (LLM), and/or the voice request;
if the first interaction request comprises a request triggered by the target event of the intelligent cockpit, first request information corresponding to the first interaction request comprises: a text request determined by the first agent according to a request generated under the trigger by the target event of the intelligent cockpit and/or the voice request.

In a possible implementation, a target agent performs an operation corresponding to the first request information, including the following steps:
calling, by the target agent, a first application programming interface (API) corresponding to the first request information;
after receiving third feedback information to be confirmed returned by the first API, feeding, by the target agent, back the third feedback information to the intelligent cockpit, and entering a listening state; and
after receiving first confirmation information regarding the third feedback information, converting, by the target agent, to a working state from the listening state, and calling a second API corresponding to the first confirmation information so as to perform an operation corresponding to the first confirmation information via the second API.

Illustratively, the calling, by the target agent, a first application programming interface (API) corresponding to the first request information, includes:
if the first interaction request comprises the text request, determining and calling, by the target agent, the first API corresponding to the text request; and/or
if the first interaction request comprises the voice request, converting, by the target agent, the voice request into a corresponding text request via a second LLM, and determining and calling the first API corresponding to the text request.

Further, the target agent is also used for converting feedback information generated during performing the operation corresponding to the first request information into corresponding first prompting information, and sending the first prompting information to a first prompting device of the intelligent cockpit, so as to output the first prompting information via the first prompting device.

Further, after acquiring a second interaction request supported by the remote agent, the first agent is also used for sending second request information corresponding to the second interaction request to the remote agent, so that the remote agent performs an operation corresponding to the second request information.

In addition, after acquiring a third interaction request complying with the second condition, the first agent is also used for generating second prompting information corresponding to the second condition; and the first agent is also used for sending the second prompting information to a second prompting device of the intelligent cockpit, so as to prompt the second prompting information via the second prompting device. The second condition includes: a function to be realized corresponding to the third interaction request being to set a function which is not supported by a vehicle provided with the intelligent cockpit, and/or the third interaction request being an interaction request which fails to be identified by the first agent.

### Exemplary Device 2

FIG. 10 is a hardware architecture diagram of an intelligent cockpit of a vehicle provided by an exemplary embodiment of the present disclosure. The vehicle may perform the intelligent cockpit interaction method provided by the various embodiments of the present disclosure described above. The vehicle may include an intelligent connected vehicle. The intelligent connected vehicle is a new generation of vehicle which integrates advanced sensor, controller, actuator and communication technology. It can realize all-round link between vehicle and vehicle, vehicle and road, vehicle and people, vehicle and service platform.

In one embodiment, the intelligent cockpit of the vehicle may include a computing platform 100, a sensing system 200, a positioning and navigating system 300, and a drive control system 400. In one example, the computing platform 100, the sensing system 200, the positioning and navigating system 300, the communication system, and the drive control system 400 cooperate to implement the intelligent driving functions of the vehicle. Thus, for purposes of generalization, the collection of hardware such as the computing platform 100, the sensing system 200, the positioning and navigating system 300, and the drive control system 400, and their corresponding software, may be referred to as an intelligent driving domain.

The computing platform 100, acting as the “brain” of the vehicle, is responsible for processing data collected by the sensing system 200, positioning and navigating systems 300, etc., performing relevant algorithms and making decisions, and controlling the drive control system 400 to perform the decisions to achieve the relevant functions of automatic/assisted driving (or intelligent driving) of the vehicle.

Computing platform 100 may include one or more processors, e.g. processors 111 to 11n. In one implementation, multiple processors of computing platform 100 may be separate devices from one another or may be integrated together.

In this disclosure, computing platform 100 may run various agents, such as a first agent and a second agent, where a large language model (LLM) may be set, or where the LLM is accessible. The first agent and the second agent cooperate to implement the intelligent cockpit interaction method provided by the various embodiments of the present disclosure described above.

In one implementation, computing platform 100 may also include one or more memories 120 in which processor-executable program instructions, algorithms may be stored, and the processors may load and execute the program instructions, algorithms in memory 120 to perform corresponding functions.

Illustratively, the memory 120 may include, for example, volatile memory, such as dynamic random access memory (DRAM), static random access memory (SRAM), etc.; and a non-volatile memory (NVM), such as read-only memory (ROM), flash memory, etc. Illustratively, the memory can reside separately from the processor, coupled to the processor by a bus, or it can be integral to the processor as part of the processor.

The sensing system 200 acts as a “sensory” to the vehicle and is responsible for sensing the vehicle's surroundings and collecting real-time data about the vehicle's surroundings.

The positioning and navigating system 300 is used for positioning a vehicle and planning a travel route when navigating. The positioning and navigating system 300 may include a global navigation satellite system (GNSS) 310 for providing position information of the vehicle, such as a global positioning satellite system (GPS), a beidou navigation satellite system (BDS), a Galileo positioning system, etc., and the embodiments of the present disclosure are not limited thereto. An inertial measurement unit (IMU) 320, including accelerometers, gyroscopes, and the like, is used to provide the motion state information of the vehicle. High-precision map data is used for providing accurate road information.

In the present disclosure, the positioning of the vehicle may be accomplished based on the positioning and navigating system 300, to obtain positioning information for the vehicle, such that the computing platform 100 navigates the vehicle based on the positioning information for the vehicle and a navigation planning agent of the first agent and the second agent.

The driving control system 400 can perform the decision of the computing platform 100 or perform the driver's intention, perform driving control on the vehicle, for example, control acceleration, deceleration, braking, steering, braking force distribution, anti-lock, electronic stabilization, energy recovery, etc. of the vehicle, and coordinate electric energy distribution of the motor and other in-vehicle apparatus (e.g. air conditioner, lights, audio sound, display screen, etc.) of the electric vehicle, thereby improving the energy utilization efficiency of the whole vehicle, and extending the mileage range. In one implementation, the functions of the drive control system 400 may be implemented through one or more electronic control units (ECU), such as ECU 411 to ECU 41n, by performing instructions of the computing platform 100, and the embodiments of the present disclosure are not limited thereto.

In one embodiment, the intelligent cockpit may also include an infotainment system 500. The infotainment system 500 may include, for example, a display apparatus 510, an interaction apparatus 520, an environmental apparatus 530, etc. In one implementation, the various apparatuses in the infotainment system 500 cooperate to implement functions within the vehicle cockpit, such as infotainment, instrument display, human-computer interaction, environmental control, etc. Thus, for the sake of generalization, the collection of hardware such as the display apparatus 510, the interaction apparatus 520, the environment apparatus 530, and the corresponding software may be referred to as a cockpit domain.

Display apparatus 510 may include one or more display screens. In one implementation, the display apparatus 510 may include a digital instrument display screen located in front of the driver's seat, a central control screen 512 located in the central control area, and a secondary driver screen 513 located in front of the secondary driver seat. A digital instrument display screen is used to replace a conventional instrument panel, and can be used to display key information about a vehicle, such as speed, rotational speed, fuel consumption, power consumption, temperature, warning information, navigation indication, driving assistance system status, vehicle fault warning, etc. The central control screen 512 is used for providing an infotainment function of a vehicle, such as audio playing, video playing, a navigating system, Bluetooth connection, mobile screen mirroring, display of reverse image, display of 360-degree panoramic image, display of information related to an intelligent driving, etc. In addition, the center control screen 512 may also provide functional settings of the vehicle, such as adjustment of air conditioner, seats, lights, driving modes, power output configurations, etc. In addition, the center control screen 512 may also provide human-computer interaction functions of the vehicle, such as touch control, gesture control, etc. to turn on/off air conditioners, adjust seats, play/stop music, turn on/off navigation, turn on/off lights, etc. The secondary driver screen 513 may be used to provide entertainment or information services to the secondary driver occupants, such as playing music, video, providing game content, displaying navigation information, etc.

In one implementation, the display apparatus 510 may also include a head-up display (HUD) 514 that may project critical information about the vehicle, such as speed, navigation directions, etc. onto the front windshield of the vehicle so that the driver does not need to look at the dashboard or instrument display screen below to see the information, thereby preventing the user from shifting the line of sight while driving, and improving driving safety and comfort.

In one implementation, the display apparatus 510 may include one or more of a digital instrument panel 511, a central control panel 512, an secondary driver screen 513, and a head-up display 514.

In this disclosure, the display apparatus 510 may display the first prompting information and/or the second prompt information under direction of the computing platform 100.

The interaction apparatus 520 may include a speaker 521, a microphone 522, an in-cockpit camera 523, keys 524, etc. Here, the number of the speakers 521 may be plural, and the plural speakers 521 may be distributed at different positions in the cockpit. The microphone 522 may be a single microphone 522 or an array of multiple microphones 522, and the microphone 522 may collect the voice of the user in the cockpit, so as to realize the functions of voice recognition, call noise reduction, etc. The in-cockpit camera 523 may collect an image of a user in the cockpit, and the keys 524 may allow the user to set vehicle functions or control the vehicle by pressing or touching.

Further, the interaction apparatus 520 may also include an ultrasonic sounder 525, which may be used to send an ultrasonic signal.

The environmental apparatuses 530 may include, for example, an air conditioner system, a fresh air system, a fragrance system, a lighting system, a seat heating/ventilation/massage system, etc. In one implementation, the environmental apparatus 530 may be controlled by a user through the interaction apparatus 520 or linkage controlled by the processor based on the state of use of the vehicle, temperature within the cockpit, humidity, and the like.

In one embodiment, the vehicle may also include a bus system 600, which may enable intercommunication between apparatuses within the vehicle.

Illustratively, bus system 600 may include, for example, a controller area network (CAN) bus, an inter-integrated circuit (I2C) interface, an inter-integrated circuit sound (I2S) interface, and a pulse code modulation (PCM) interface, a universal asynchronous receiver/transmitter (UART) interface, a mobile industry processor interface (MIPI) interface and a general-purpose input/output (GPIO) interface, a local interconnect network (LIN) bus, a FlexRay bus, a media oriented system transport (MOST) bus, a vehicle-mounted Ethernet bus, etc. so as to realize data transmission between the computing platform 100, the perception system 200, the positioning and navigating system 300, the driving control system 400 or other apparatuses/systems in the vehicle.

In one embodiment, the vehicle may also include a communication module 700 that enables the vehicle to be interconnected with other electronic apparatuses, such as cell phones, tablets, etc. as well as to enable the vehicle to access the internet. In one implementation, the communication module 700 may include, for example, a mobile communication module 710 and a wireless communication module 720.

The mobile communication module 710 is used for enabling a vehicle to access the internet based on a mobile communication technology such as 2G, 3G, 4G, 5G, etc. to communicate with a server, other vehicles, a base station, an intelligent apparatus, etc. which may access the internet. The mobile communication module 710 may include at least one filter, switch, power amplifier, low noise amplifier (LNA), modem, etc. The wireless communication module 720 is used for realizing the functions of wireless fidelity (Wi-Fi), Bluetooth (BT) and near-field communication (NFC) of the vehicle, so as to realize the wireless connection between the vehicle and the mobile phone and other electronic apparatuses, cross-apparatus call and media flow, provide a wireless hot spot, and realize the keyless entry and non-inductive payment of the NFC, etc.

Advantageous effects corresponding to the exemplary embodiments of the present mean can be seen in the respective advantageous effects of the exemplary method section described above and will not be described in detail here.

### Exemplary Electronic Apparatus

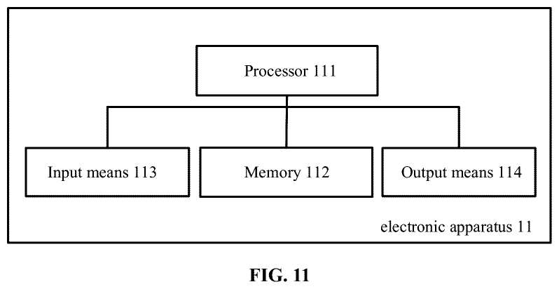

FIG. 11 is a structure diagram of an electronic apparatus including at least one processor 11 and memory 12 provided according to an embodiment of the present disclosure.

The processor 11 may be a central processing unit (CPU) or other form of processing unit having data processing capabilities and/or instruction performing capabilities, and may control other components in the electronic apparatus 10 to perform desired functions.

The memory 12 may include one or more computer program products, which may include various forms of computer-readable storage media, such as volatile memory and/or non-volatile memory. Volatile memory can include, for example, random access memory (RAM) and/or cache memory, etc. The non-volatile memory may include, for example, a read only memory (ROM), a hard disk, a flash memory, etc. One or more computer program instructions may be stored on the computer readable storage medium, and the processor 11 may perform the one or more computer program instructions to implement the intelligent cockpit interaction method and/or other desired functions of the various embodiments of the present disclosure hereinabove.

In one example, the electronic apparatus 10 may further include: an input means 13 and an output means 14, these components are interconnected by a bus system and/or other form of connection mechanism (not shown).

The output means 14 may output various information to the outside, including a display, a speaker, a printer, and a communication network and a remote output apparatus connected thereto, etc. Illustratively, the display may be used to display the first prompting information and/or the second prompting information.

Of course, for simplicity, only some of the components of the electronic apparatus 10 relevant to the present disclosure are shown in FIG. 11, omitting components such as buses, input/output interfaces, and the like. In addition, the electronic apparatus 10 may include any other suitable components, depending on the particular application.

### Exemplary Computer Program Product and Computer-Readable Storage Medium

In addition to the methods and apparatus described above, embodiments of the present disclosure may also provide a computer program product including computer program instructions that, when executed by a processor, cause the processor to perform the steps in the intelligent cockpit interaction methods of the various embodiments of the present disclosure described in the “Exemplary method” section above.

The computer program product may include program code for performing operations of embodiments of the present disclosure written in any combination of one or more programming languages, including object-oriented programming languages, such as Java, C++, etc. and conventional procedural programming languages, such as the “C” language or similar programming languages. The program code may perform entirely on the user computing apparatus, partially on the user apparatus, as a stand-alone software package, partially on the user computing apparatus, partially on a remote computing apparatus, or entirely on the remote computing apparatus or server.

Further, embodiments of the present disclosure may also be a computer-readable storage medium having stored thereon computer program instructions that, when executed by a processor, cause the processor to perform the steps in the intelligent cockpit interaction methods of the various embodiments of the present disclosure described in the “Exemplary method” section above.

The computer-readable storage medium may take any combination of one or more of the readable media. The readable medium may be a readable signal medium or a readable storage medium. A readable storage medium is exemplified by, but not limited to, a system, mean, or device including an electronic, magnetic, optical, electromagnetic, infrared, or semiconductor device, or a combination according to any of the foregoing. More specific examples (a non-exhaustive list) of the readable storage medium include: an electrical connection having one or more wires, a portable disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

While the general principles of the present disclosure have been described above in connection with specific embodiments, the advantages, benefits, effects, and the like set forth in the present disclosure are merely exemplary and not limiting, and are not to be construed as necessarily required by the various embodiments of the present disclosure. Further, the specific details disclosed above are only for the purpose of illustration and ease of understanding, and not for limitation. The above details do not limit the present disclosure to be implemented strictly in accordance with those specific details.

It will be apparent to those skilled in the art that various modifications and variations can be made in the disclosure without departing from the spirit or scope of the disclosure. Thus, the disclosure is also intended to include the modifications and variations if such modifications and variations fall within the scope of the claims of the disclosure and their equivalents.

What is claimed is:

1. A method for intelligent cockpit interaction, the intelligent cockpit comprising a first agent and at least one second agent, the method comprising:
determining, at the first agent, at least one target agent for processing a first interaction request from among the at least one second agent after the first interaction request is acquired;
sending, at the first agent, a first request information corresponding to the first interaction request to the at least one target agent; and
performing, at the target agent, an operation corresponding to the first request information.

2. The method according to claim 1, wherein the sending, at the first agent, a first request information corresponding to the first interaction request to the at least one target agent, comprises:
in response to that the at least one target agent comprises two or more target agents, splitting, at the first agent, the first interaction request into sub-requests respectively corresponding to the target agents; and
sending, at the first agent, sub-request information respectively corresponding to the sub-requests to the respective target agents.

3. The method according to claim 2, wherein the sending, at the first agent, sub-request information respectively corresponding to the sub-requests to the respective target agent, comprises:
sending, at the first agent, sub-request information respectively corresponding to the sub-requests to the respective target agents within a target duration range; or
sending, at the first agent, first sub-request information corresponding to a first sub-request among the sub-requests to a first target agent; and
in response to that the first target agent satisfies a first condition, sending, at the first agent, second sub-request information corresponding to a second sub-request among the sub-requests to a second target agent.

4. The method according to claim 3, wherein
in response to that the first target agent sends a first feedback information about successful operation to the first agent after completing the operation corresponding to the first request information, the first condition comprises: the first agent receives the first feedback information; and/or
in response to that the first target agent enters into the listening state after feeding back the second feedback information to be confirmed in the process of performing the operation corresponding to the first request information, the first condition comprises: the first target agent is in a state other than a working state and a listening state for waiting for confirmation of a second feedback information.

5. The method according to claim 1, wherein
the first interaction request comprises: a voice request and/or a request triggered by a target event of the intelligent cockpit;
in response to that the first interaction request comprises a voice request, the first request information corresponding to the first interaction request comprises: a text request converted by the first agent from the voice request via a first large language model (LLM), and/or the voice request;
in response to that the first interaction request comprises a request triggered by the target event of the intelligent cockpit, first request information corresponding to the first interaction request comprises: a text request determined by the first agent according to the request triggered by the target event of the intelligent cockpit and/or the voice request.

6. The method according to claim 1, wherein the performing, at the target agent, an operation corresponding to the first request information, comprises:
calling, at the target agent, a first application programming interface (API) corresponding to the first request information;
after receiving third feedback information to be confirmed returned by the first API, feeding, at the target agent, back the third feedback information to the intelligent cockpit, and entering a listening state; and
after receiving first confirmation information regarding the third feedback information, converting, at the target agent, into a working state from the listening state, and calling a second API corresponding to the first confirmation information so as to perform an operation corresponding to the first confirmation information via the second API.

7. The method according to claim 6, wherein the calling, at the target agent, a first application programming interface (API) corresponding to the first request information, comprises:
in response to that the first interaction request comprises the text request, determining and calling, at the target agent, the first API corresponding to the text request; and/or
in response to that the first interaction request comprises the voice request, converting, at the target agent, the voice request into a corresponding text request via a second LLM, and determining and calling, at the target agent, the first API corresponding to the text request.

8. The method according to claim 1, further comprising:
converting, at the target agent, fourth feedback information generated during process of performing an operation corresponding to the first request information into first prompting information; and
sending, at the target agent, the first prompting information to a first prompting device of the intelligent cockpit, so as to output the first prompting information via the first prompting device.

9. The method according to claim 1, wherein the intelligent cockpit supports interaction with a remote agent, the method further comprises:
after acquiring a second interaction request supported by the remote agent, sending, at the first agent, second request information corresponding to the second interaction request to the remote agent, so as to perform an operation corresponding to the second request information by the remote agent.

10. The method according to claim 1, further comprising:
after acquiring a third interaction request complying with a second condition, generating, at the first agent, second prompting information corresponding to the second condition; and
sending, at the first agent, the second prompting information to a second prompting device of the intelligent cockpit, so that the second prompting information is prompted via the second prompting device.

11. The method according to claim 10, wherein
the second condition comprises: a function to be realized corresponding to the third interaction request being a function which is not supported by a vehicle provided with the intelligent cockpit, and/or the third interaction request being an interaction request which fails to be identified by the first agent.

12. A computer-readable storage medium storing a computer program thereon which, when executed by a processor, cause the processor to perform a method for intelligent cockpit interaction, the intelligent cockpit comprising a first agent and at least one second agent, the method comprising:
determining, at the first agent, at least one target agent for processing a first interaction request from among the at least one second agent after the first interaction request is acquired;
sending, at the first agent, a first request information corresponding to the first interaction request to the at least one target agent; and
performing, at the target agent, an operation corresponding to the first request information.

13. An electronic apparatus, comprising:
a processor;
a memory for storing processor-executable instructions;
wherein the processor being used for reading the executable instructions from the memory and performing the instructions to implement a method for intelligent cockpit interaction, the intelligent cockpit comprising a first agent and at least one second agent, the method comprising:
determining, at the first agent, at least one target agent for processing a first interaction request from among the at least one second agent after the first interaction request is acquired;
sending, at the first agent, a first request information corresponding to the first interaction request to the at least one target agent; and
performing, at the target agent, an operation corresponding to the first request information.

14. The electronic apparatus according to claim 13, wherein the sending, at the first agent, a first request information corresponding to the first interaction request to the at least one target agent, comprises:
in response to that the at least one target agent comprises two or more target agents, splitting, at the first agent, the first interaction request into sub-requests respectively corresponding to the target agents; and
sending, at the first agent, sub-request information respectively corresponding to the sub-requests to the respective target agents.

15. The electronic apparatus according to claim 14, wherein the sending, at the first agent, sub-request information respectively corresponding to the sub-requests to the respective target agent, comprises:
sending, at the first agent, sub-request information respectively corresponding to the sub-requests to the respective target agents within a target duration range; or
sending, at the first agent, first sub-request information corresponding to a first sub-request among the sub-requests to a first target agent; and
in response to that the first target agent satisfies a first condition, sending, at the first agent, second sub-request information corresponding to a second sub-request among the sub-requests to a second target agent.

16. The electronic apparatus according to claim 15, wherein
in response to that the first target agent sends a first feedback information about successful operation to the first agent after completing the operation corresponding to the first request information, the first condition comprises: the first agent receives the first feedback information; and/or
in response to that the first target agent enters into the listening state after feeding back the second feedback information to be confirmed in the process of performing the operation corresponding to the first request information, the first condition comprises: the first target agent is in a state other than a working state and a listening state for waiting for confirmation of a second feedback information.

17. The electronic apparatus according to claim 13, wherein
the first interaction request comprises: a voice request and/or a request triggered by a target event of the intelligent cockpit;
in response to that the first interaction request comprises a voice request, the first request information corresponding to the first interaction request comprises: a text request converted by the first agent from the voice request via a first large language model (LLM), and/or the voice request;
in response to that the first interaction request comprises a request triggered by the target event of the intelligent cockpit, first request information corresponding to the first interaction request comprises: a text request determined by the first agent according to the request triggered by the target event of the intelligent cockpit and/or the voice request.

18. The electronic apparatus according to claim 13, wherein the performing, at the target agent, an operation corresponding to the first request information, comprises:
calling, at the target agent, a first application programming interface (API) corresponding to the first request information;
after receiving third feedback information to be confirmed returned by the first API, feeding, at the target agent, back the third feedback information to the intelligent cockpit, and entering a listening state; and
after receiving first confirmation information regarding the third feedback information, converting, at the target agent, into a working state from the listening state, and calling a second API corresponding to the first confirmation information so as to perform an operation corresponding to the first confirmation information via the second API.

19. The electronic apparatus according to claim 18, wherein the calling, at the target agent, a first application programming interface (API) corresponding to the first request information, comprises:
in response to that the first interaction request comprises the text request, determining and calling, at the target agent, the first API corresponding to the text request; and/or
in response to that the first interaction request comprises the voice request, converting, at the target agent, the voice request into a corresponding text request via a second LLM, and determining and calling, at the target agent, the first API corresponding to the text request.

20. The electronic apparatus according to claim 13, further comprising:
converting, at the target agent, fourth feedback information generated during process of performing an operation corresponding to the first request information into first prompting information; and
sending, at the target agent, the first prompting information to a first prompting device of the intelligent cockpit, so as to output the first prompting information via the first prompting device.
